(19) United States
(12) Patent Application Publication
(10) Pub. No.: US 2021/0304346 A1
(43) Pub. Date: Sep. 30, 2021

(54) SYSTEMS AND METHODS FOR TRANSPORTING A RIDER TO A DESTINATION BASED ON POSITION COORDINATES OF A COMPUTING DEVICE

(71) Applicant: Lenovo Enterprise Solutions (Singapore) Pte. Ltd., New Tech Park (SG)

(72) Inventors: Jennifer Lee-Baron, Research Triangle Park, NC (US); John Crowe, Research Triangle Park, NC (US); Gary Cudak, Research Triangle Park, NC (US); Nathan Peterson, Research Triangle Park, NC (US)

(21) Appl. No.: 16/836,526

(22) Filed: Mar. 31, 2020

(51) Int. Cl. G06Q 50/30; G06Q 10/02; G01S 19/25; H04W 4/021; H04W 4/029

(52) U.S. Cl. CPC G06Q 50/30; G06Q 10/02; H04W 4/029; H04W 4/021; G01S 19/256

(57) ABSTRACT

Systems and method for transporting a rider to a destination based on position coordinates of a computing device are disclosed. According to an aspect, a method includes receiving a request for transportation to a destination proximate a mobile computing device. The method also includes determining position coordinates of the mobile computing device. Further, the method includes communicating, to a computing device of a driver associated with the request, the position coordinates of the mobile computing device for indicating the position coordinates as the destination for the request. The method also includes determining updated positioned coordinates of the mobile computing device. Further, the method includes communicating, to the computing device of the driver associated with the request, the updated position coordinates of the mobile computing device.

### TECHNICAL FIELD

The presently disclosed subject matter relates generally to transportation. Particularly, the presently disclosed subject matter relates to systems and methods for transporting a rider to a destination based on position coordinates of a computing device.

### BACKGROUND

Ride sharing services have become an increasingly popular alternative to automobile rentals and taxis. Typically, ride sharing services are available to people via applications (also known as “apps”) residing on their mobile computing devices. For example, a person may be at the airport and need travel to a nearby hotel. In this example, the person may activate a ride sharing application on her or his smartphone in order to request transportation. The person's smartphone may send a ride request to a web server that manages the ride sharing service. Based on the location and intended destination of the person, the ride sharing service can assist with coordinating a ride for the person with an available driver.

A driver associated with a ride sharing service may have a smartphone, tablet computer, or the like for managing his or her driving tasks. For example, the ride sharing service's server may communicate available jobs for the driver and request that the driver accept a job for transporting a rider to a specified destination. Once a driver accepts a job, the driver's computing device may display directions to pick up the rider and also directions for driving the rider to the destination. It is desired to improve the efficiency of systems and techniques for ride sharing services, particularly the efficiency of the driver in transporting a rider to the desired destination.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is a block diagram of a block diagram of a system for indicating position coordinates of a mobile computing device as a ride destination in accordance with embodiments of the present disclosure;

FIG. 2 is a flow diagram of a method for implementing a ride request and for indicating position coordinates of a mobile computing device as a ride destination of the ride request in accordance with embodiments of the present disclosure;

FIG. 3 is a geographic map showing positions of a rider's computing device, a driver's computing device, and a destination computing device with respect to each other in accordance with embodiments of the present disclosure; and

FIG. 4 is a flow diagram of another method for implementing a ride request and for indicating position coordinates of a mobile computing device as a ride destination of the ride request in accordance with embodiments of the present disclosure.

### SUMMARY

The presently disclosed subject matter relates to systems and methods for transporting a rider to a destination based on position coordinates of a computing device. According to an aspect, a method includes receiving a request for transportation to a destination proximate a mobile computing device. The method also includes determining position coordinates of the mobile computing device. Further, the method includes communicating, to a computing device of a driver associated with the request, the position coordinates of the mobile computing device for indicating the position coordinates as the destination for the request. The method also includes determining updated positioned coordinates of the mobile computing device. Further, the method includes communicating, to the computing device of the driver associated with the request, the updated position coordinates of the mobile computing device.

According to another aspect, a method includes receiving, at a computing device, a request for transportation to a destination proximate a mobile computing device. Further, the method includes determining first position coordinates of the mobile computing device at a first time. The method also includes presenting directions for driving to the determined first position coordinates. Further, the method includes determining second position coordinates of the mobile computing device at a second time different than the first time. The method also includes presenting directions for driving to the determined second position coordinates.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

The functional units described in this specification have been labeled as computing devices. A computing device may be implemented in programmable hardware devices such as processors, digital signal processors, central processing units, field programmable gate arrays, programmable array logic, programmable logic devices, cloud processing systems, or the like. The computing devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together but may comprise disparate instructions stored in different locations which, when joined logically together, comprise the computing device and achieve the stated purpose of the computing device. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD), or a smart watch or some other wearable smart device. Some of the computer sensing may be part of the fabric of the clothes the user is wearing. A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, smart watch, or the like) that is capable of sending and receiving data in a wireless manner using protocols like the Internet Protocol, or IP, and the wireless application protocol, or WAP. This allows users to access information via wireless devices, such as smart watches, smart phones, mobile phones, pagers, two-way radios, communicators, and the like. Wireless data access is supported by many wireless networks, including, but not limited to, Bluetooth, Near Field Communication, CDPD, CDMA, GSM, PDC, PHS, TDMA, FLEX, ReFLEX, iDEN, TETRA, DECT, DataTAC, Mobitex, EDGE and other 2G, 3G, 4G, 5G, and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone or smart watch that operates over GPRS (General Packet Radio Services), which is a data technology for GSM networks or operates over Near Field Communication e.g. Bluetooth. In addition to a conventional voice communication, a given mobile device can communicate with another such device via many different types of message transfer techniques, including Bluetooth, Near Field Communication, SMS (short message service), enhanced SMS (EMS), multi-media message (MMS), email WAP, paging, or other known or later-developed wireless data formats. Although many of the examples provided herein are implemented on smart phones, the examples may similarly be implemented on any suitable computing device, such as a computer.

An executable code of a computing device may be a single instruction, or many instructions, and may even be distributed over several different code segments, among different applications, and across several memory devices. Similarly, operational data may be identified and illustrated herein within the computing device, and may be embodied in any suitable form and organized within any suitable type of data structure. The operational data may be collected as a single data set, or may be distributed over different locations including over different storage devices, and may exist, at least partially, as electronic signals on a system or network.

The described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used herein, the term “memory” is generally a storage device of a computing device. Examples include, but are not limited to, read-only memory (ROM) and random access memory (RAM).

The device or system for performing one or more operations on a memory of a computing device may be a software, hardware, firmware, or combination of these. The device or the system is further intended to include or otherwise cover all software or computer programs capable of performing the various heretofore-disclosed determinations, calculations, or the like for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl, or other suitable programming languages.

As referred to herein, the terms “computing device” and “entities” should be broadly construed and should be understood to be interchangeable. They may include any type of computing device, for example, a server, a desktop computer, a laptop computer, a smart phone, a cell phone, a pager, a personal digital assistant (PDA, e.g., with GPRS NIC), a mobile computer with a smartphone client, or the like.

As referred to herein, a user interface is generally a system by which users interact with a computing device. A user interface can include an input for allowing users to manipulate a computing device, and can include an output for allowing the system to present information and/or data, indicate the effects of the user's manipulation, etc. An example of a user interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or times program instructions thereon for causing a processor to carry out aspects of the present disclosure.

As referred to herein, a computer network may be any group of computing systems, devices, or equipment that are linked together. Examples include, but are not limited to, local area networks (LANs) and wide area networks (WANs). A network may be categorized based on its design model, topology, or architecture. In an example, a network may be characterized as having a hierarchical internetworking model, which divides the network into three layers: access layer, distribution layer, and core layer. The access layer focuses on connecting client nodes, such as workstations to the network. The distribution layer manages routing, filtering, and quality-of-server (QoS) policies. The core layer can provide high-speed, highly-redundant forwarding services to move packets between distribution layer devices in different regions of the network. The core layer typically includes multiple routers and switches.

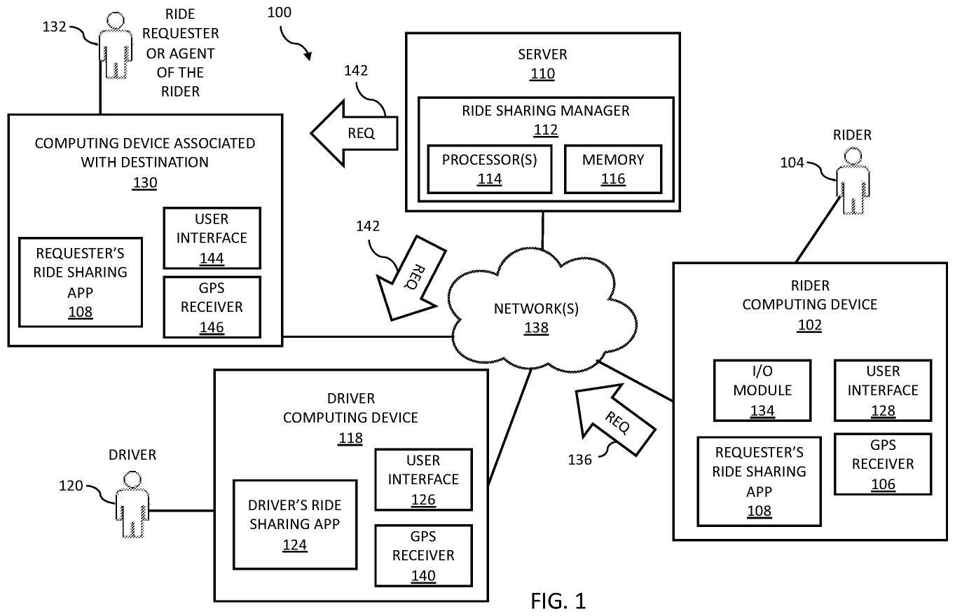

FIG. 1 illustrates a block diagram of a system 100 for indicating position coordinates of a mobile computing device as a ride destination in accordance with embodiments of the present disclosure. Referring to FIG. 1, the system 100 includes a computing device 102 of a prospective rider 104 for a ride sharing service. The computing device 102 may be held or otherwise carried by the rider 104 so that the position of the rider 104 may be determined for pickup by the ride sharing service. The computing device 102 may include a GPS receiver 106 and/or other suitable hardware, software, firmware, or combinations thereof for determining a position of the rider. A ride sharing application 108 may reside on the computing device 102 and may be configured to request and receive current coordinates from the GPS receiver 106 for the purpose of a system of the ride sharing service of the current coordinates.

A server 110, such as a web server, may be communicatively connected to the computing device 102 for receiving ride requests and for receiving current coordinates or other location information for use in locating the rider 104 for pickup or for reporting location of travel of the rider 104 to a destination. For example, the coordinates may be used by a driver for use in determining where to pick up the rider 104. In another example, the server 110 can send the coordinates to a computing device of another who is authorized to receive information about the travel of the rider 104 to his or her destination. For example, the driver 104 or another person who organized and/or has administrative rights associated with the travel of the rider 104 may receive travel information about the rider 104, such as coordinates or other location information of the rider 104 as the rider 104 is transported to his or her destination.

In accordance with embodiments, the server 110 may be configured to receive a request for transportation to a destination proximate a mobile computing device, to determine current position coordinates of the mobile computing device, and to communicate to a computing device of a drive associated with the request the current position coordinates of the mobile computing device for indicating the current position coordinates as the destination for the request. The server 110 may include a ride sharing manager 112 for implementing these functionalities and others described herein. The ride sharing manager 112 may include hardware, software, firmware, or combinations thereof for implementing these functionalities and others described herein. For example, the ride sharing manager 112 may include one or more processors 114 and memory 116. The memory 116 may store instructions for implementation by the processor(s) 114.

The system 100 includes a computing device 118 of a driver 120. The driver's computing device 118 may be any suitable mobile computing device, such as a smart phone or tablet computer. A ride sharing application 122 may reside on the driver's computing device and may be configured to present to the driver 120 information about a ride request originating from a prospective rider or another who is requesting a ride for the prospective rider. The driver's computing device 118 may include a user interface 126 that can be controlled by the ride sharing application 122 to present the ride request to the driver 120. The ride request may include information such as, but not limited to, identification of the rider, a location of the rider, a driving distance and/or travel time to the rider, a travel time and/or distance from the driver to the rider's destination, and/or other information about the prospective rider. As an example, the user interface 126 may include a touchscreen display that can display the ride request. Further, in this example, the driver 120 may interact with the user interface 126 (e.g., the touchscreen display) to accept the ride request. In response to acceptance of the ride request, the acceptance may be communicated to the server 110 where a ride sharing transaction and process between the driver 120 and the rider and/or requester of the ride can be managed.

In an example scenario of a rider requesting a ride for herself or himself, the rider 104 may interact with a user interface 128 of her or his computing device 102 to open the ride sharing application 108. In response to being opened, the ride sharing application 108 may control the user interface 128 (e.g., a touchscreen display) to present information about drivers available for a ride to a specified destination of the rider 104. For example, the rider 104 may interact with a touchscreen display of the user interface 128 to enter destination and other travel-related information. Subsequent to entry of the destination information, the ride sharing application 108 may initiate communication of the destination information to the server 110. Upon receipt of the destination information for the rider 104, the manager 112 may manage determining prospective drivers for the ride and communicating, to the computing device 102, information about the drivers so that this information can be presented to the rider 104 via the user interface 128. Subsequently, the rider 104 may interact with the user interface 128 to select one of the drivers and to initiate the ride sharing process. The server 110 may communicate to the selected driver, such as driver 120, information about pickup and destination for the rider 104.

In accordance with embodiments, a rider or other ride requester may specify a destination for the rider by identifying another person and/or a computing device as a destination for the requested ride. For example, a computing device 130 may be identified as a destination for a requested ride for the rider 104. As an example, the rider 104 may interact with the ride sharing application 108 via the user interface 128 to identify the computing device 130 as the destination for a requested ride. Alternatively, for example, the rider 104 may identify another, such as person 132, as a destination for a requested ride. The application 124 may receive identification of the mobile device 130 and/or the person 132 as the destination, and subsequently communicate the identification to the server 110. The person 132 may be an agent of the rider 104. The manager 112 residing on the server 110 may receive the identification and coordinate travel of the rider 104 to the mobile device 130 and/or the person 132 by the driver 120. The server 110 may communicate information about the location of the mobile device 130 and/or the person 132 to the driver's computing device 118 so that the driver 120 can drive the rider 104 to the destination at the mobile device 130 or the person 132. Further, the server 110 can receive updates about the location of the mobile device 130 and/or the person 132, and subsequently communicate the updated location information to the driver's computing device 118 so that the driver 120 can re-route travel as needed to take the rider 104 to the updated location.

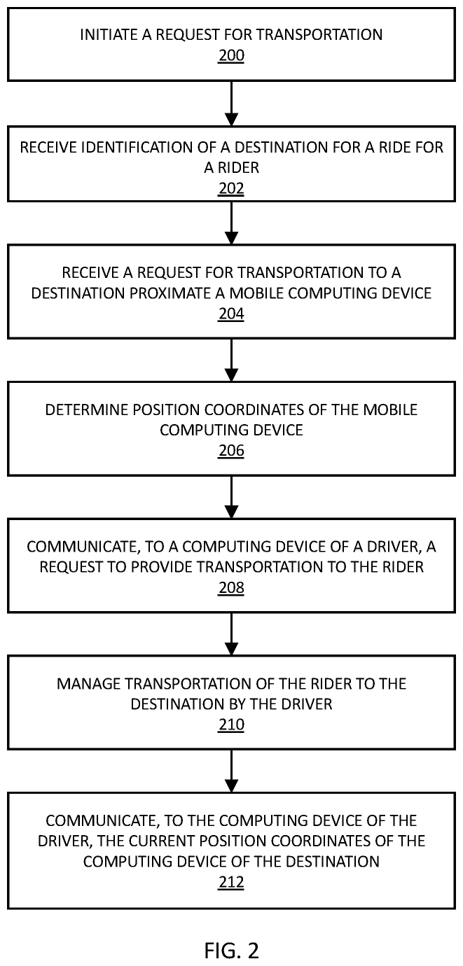

FIG. 2 illustrates a flow diagram of a method for implementing a ride request and for indicating position coordinates of a mobile computing device as a ride destination of the ride request in accordance with embodiments of the present disclosure. The method is described by example as being implemented by the system 100 shown in FIG. 1, although it should be understood that the method may be implemented by any other suitable system operable to implement ride sharing functions.

Referring to FIG. 2, the method includes initiating 200 a request for transportation. For example referring to FIG. 1, the rider 104 may interact with the user interface 128 to open the ride sharing application 108. A display of the user interface 128 may display a home screen including selectable buttons, icons, and/or other features that can be interacted with by the rider 104 for initiating request for transportation. The display of the user interface 128 may be controlled by the application 108 to display a prompt for the rider 104 to specify a destination for travel. The prompt may include, for example, a text box for entry of a destination or predefined destinations that are selectable by the rider 104.

The method of FIG. 2 includes receiving 202 identification of a destination for a ride for a rider. Continuing the aforementioned example, the rider 104 may interact with the user interface 128 to input identification of a destination, or select an identifier for a destination. For example, the rider 104 may enter an identifier of a mobile computing device and/or a person that is the desired destination for the ride. The identifier for the mobile computing device may be a telephone number or a name associated with the user or owner of the mobile computing device. This information may have been previously entered and stored by ride sharing application 108. Further, one or more identifiers indicating a mobile computing device as a destination and/or a person as a destination may be displayed or otherwise presented to the rider 104 via the user interface 128. As an example, a rider may identify a person or other mobile computing device by a general user name, actual name, or other suitable identifier.

In another example entering a ride destination, the rider 104 may touch a touchscreen display of the user interface 128 to input a destination address (e.g., a street address, city, and state). In this instance, the enter address may be provided to a driver for use in driving the rider 104 to the desired destination.

The method of FIG. 2 includes receiving 204 a request for transportation to a destination proximate a mobile computing device. Continuing the aforementioned example, the identifier indicating a mobile computing device as a destination and/or a person as a destination may be entered into the user interface 128 of the computing device 102 as previously mentioned. The entry of the identifier may be part of forming a request for transportation (or a ride) for the rider 104 to the destination mobile computing device or the person. In addition, the request may be formed by entry or otherwise receipt of information of the current location, payment information, ride sharing account information, or other associated information for initiating a ride sharing transaction. Some of all of this information may form a request 136. The ride sharing application 108 may use the I/O module 134 to send the request to the via one or more networks 138 (e.g., the Internet, wireless local area network (WLAN), cellular network, and/or the like). At the server 110, the ride sharing manager 112 may receive the request 136 for implementing the ride share for the rider 104 to the identifier of the mobile computing device or person.

The method of FIG. 2 includes determining 206 position coordinates of the mobile computing device. Continuing the aforementioned example, the ride sharing manager 112 may use the identifier of the mobile computing device or person for determining position coordinates of the mobile computing device or person. For example, the ride sharing manager 112 may maintain and store in memory 116 information for requesting position coordinates of the identified mobile computing device or person. Alternatively, upon proper authorization for doing so, the ride sharing manager 112 may temporarily store in memory 116 the position coordinates of the identified mobile computing device or person. Position coordinates may be acquired by requesting the coordinates from the computing device. As an example, the computing device itself may acquire its own location from a variety of ways including, but not limited to, a GPS technique, WI-FI® triangulation, cell tower triangulation, or the like. In an example, the identified mobile computing device may be the computing device 130 shown in FIG. 1, and the identified person may be the person 132 shown in FIG. 1.

The method of FIG. 2 includes communicating 208, to a computing device of a driver, a request to provide transportation to the rider. Continuing the aforementioned example, the rider sharing manager 112 of the server 110 can determine the driver 120 as a candidate for providing transportation. For example, the ride sharing manager 112 may maintain in memory 116 a list of drivers who are available for transporting riders. Further, the ride sharing manager 112 may determine which drivers are within a predetermined distance of and/or drive time from the rider's computing device 102 that is sufficiently close for picking up the rider 104 for transport to the destination. The ride sharing manager 112 may determine a location of the rider's computing device 102 and a location of the driver's computing device 118 for use in determining a distance between the rider 104 and the driver 120. Location information about the driver's computing device 118 may be determined by a GPS receiver 140 of the computing device 118, and the coordinates may be communicated to the server 110. Further, the ride sharing manager 112 may determine that the rider 104 and the driver 120 are within the predetermined distance and subsequently communicate a request 142 to the driver's computing device 102 to provide transportation to the rider 104. The request 142 may include information about the rider 104, the rider's location, and directions for driving to the rider 104 for pickup. The rider sharing manager 112 may make a similar determination for other prospective drivers (not shown in FIG. 1) and send a request to each of them.

The method of FIG. 2 includes managing 210 transportation of the rider to the destination by the driver. Continuing the aforementioned example, the driver 120 can accept the request to driver the rider 104 to the destination. Particularly, the ride sharing application 124 of the driver's computing device 118 can control the user interface 126 to present information of the request 142. The driver 120 may determine whether to accept the ride request for the rider 104 and use the user interface 126 to input whether the ride request is accepted or declined. The ride sharing application 124 may receive the input indicating acceptance or declination of the ride request. In response to receipt of the input, the ride sharing application 124 may communicate a message to the server 110 to indicate that the ride request is accepted or declined. If the ride request is declined, the ride sharing manager 112 may send a request to another ride or otherwise manage declination of the ride request. If the ride request is accepted, the ride sharing manager 112 may communicate the acceptance to the rider's computing device 102 along with information about the driver 120, such as a description of the driver's automobile, estimated time of arrival for pickup, and the like. Subsequently, the rider 104 may await pickup by the driver 120, and the driver's computing device 102 may communicate updates about its location to the server 110 for updating the driver's computing device 118 with the rider's 104 current location.

The method of FIG. 2 may communicate 212, to the computing device of the driver, the current position coordinates of the mobile computing device of the destination for the transportation for indicating the current position coordinates as the destination for the ride request. Continuing the aforementioned example, the ride sharing manager 112 may generate a request 144 for communication to the computing device 130 based on identification of the computing device 130 and/or the person 132 being identified as a destination for the requested ride. The request 144 may include a request for current position coordinates of the computing device 130 along with other relevant information about transportation of the rider 104 by the driver 120. The server 110 may send the request 142 to the computing device 130 via the network(s) 138. The ride sharing application 108 may use a user interface 144 to present the request to the person 132. Further, the rider sharing application 108 may receive the request and use a GPS receiver 146 of the computing device 130 to acquire current position coordinates. Subsequently, the current position coordinates may be communicated to the server 110 for relay to the driver's computing device 118. The driver's ride sharing application 124 may present the current position coordinates of the computing device 130 via the user interface 126. Further, the driver's ride sharing application 124 may update a navigation system on the computing device 118 to use the user interface 144 to present directions for driving to the computing device 130. It is also noted that the computing device 130 may subsequently provide one or more positions coordinates updates to the server 110 such that it may provide the update(s) to the computing device 118. The driver's ride sharing application 124 may use the updates to notify the driver 120 via the user interface 144 and to update the navigation system such that the drive route may be updated.

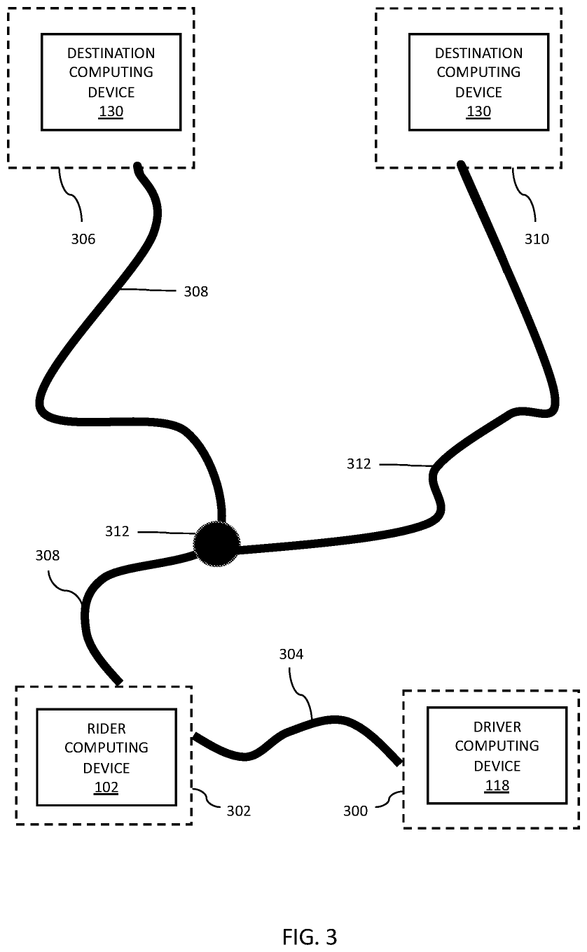

FIG. 3 illustrates a geographic map showing positions of a rider's computing device 102, a driver's computing device 118, and a destination computing device 130 with respect to each other in accordance with embodiments of the present disclosure. Referring to FIG. 3, the rider's computing device communicates a ride request to a server, such as server 110 shown in FIG. 1. The ride request may identifier the rider and the current position coordinates of the rider's computing device 102. Updates of the position coordinates of the rider's computing device 102 may be periodically provided to the server. The server may communicate the request to the driver's computing device 118 that is positioned generally with a geographic area 300. The geographic area 300 or any other geographic area described with respect to this figure may be specified by a single set of coordinates, boundaries of an area, or the like.

With continuing reference to FIG. 3, the driver may accept the ride request, and communication of the acceptance may be communicated to the server. The server may subsequently communicate notification of acceptance of the ride request by the driver to the rider's computing device 102. A user interface of the rider's computing device 102 may present to the rider indication of acceptance of the ride request. Further, the current position coordinates (generally within geographic area 302) of the rider's computing device 102 may be communicated to the driver's computing device 118. Based on the received position coordinates, the driver's computing device 118 may present to the driver a map and directions for driving to the location of the rider's computing device 102 for pickup of the rider. For instance, the map and directions may be provided on a display of the driver's computing device 118 to drive along one or more roads 304 in specified directions for pickup of the rider. The endpoint for the drive to pick up the rider may be at geographic location 302, where the rider is located. Once reaching the geographic location where the driver is located, the driver may pick up the rider in his or her automobile and subsequently begin travel to the rider's destination at computing device 130.

With continuing reference to FIG. 3, the destination computing device 130 may be initially positioned within geographic area 306. In this case, position coordinates identifying the geographic area 306 are initially sent to the driver for transporting the rider to the geographic area 306. The driver's computing device 118 may present directions for driving to the geographic area 306 along a first set of one or more roads 308. Subsequently, the user of computing device 130 may move within the geographic area, and updated position coordinates may be communicated to the driver's computing device 118 in accordance with embodiments of the present disclosure. In this case since the destination computing device 130 is still within the geographic area 130, the driving directions for the driver will still be along the first set of road(s) 308. The coordinate position of the computing device 130 may be monitored and the driver's computing device 118 updated with any changes.

In response to the destination computing device 130 being moved to another geographic area 310, the new position coordinates may be communicated to the driver's computing device 118. The new position of the destination computing device 130 within geographic location 310 may be such that the driving directions are different for the driver to drive to the destination computing device 130. For example, the driver's computing device 118 may receive the new position coordinates when the driver is located point 314 or at a location before reaching point 314 on the first set of road(s) 308. In this case, the driver's computing device 118 may update the driving directions and map based on the new position coordinates such that the driver is routed along another second set of one or more roads 312 for driving to the new position of the destination computing device 130 at geographic location 310. In this way, as the position of the destination computing device 130 changes, the driver can be updated with the new position information in order to change a driving route taken to arrive at the destination computing device 130. Such an update in position and corresponding update to driving directions may occur multiple times while the rider is being driven to the destination (i.e., the location of the computing device 130).

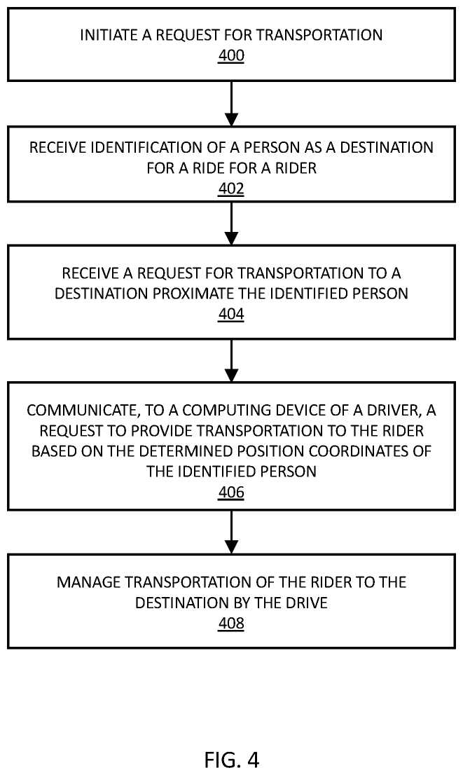

FIG. 4 illustrates a flow diagram of another method for implementing a ride request and for indicating position coordinates of a mobile computing device as a ride destination of the ride request in accordance with embodiments of the present disclosure. The method is described by example as being implemented by the system 100 shown in FIG. 1, although it should be understood that the method may be implemented by any other suitable system operable to implement ride sharing functions.

Referring to FIG. 4, the method includes initiating 400 a request for transportation. For example referring to FIG. 1, the rider 104 may interact with the user interface 128 to open the ride sharing application 108. The display of the user interface 128 may be controlled by the application 108 to display a prompt for the rider 104 to specify a destination for travel. The prompt may include, for example, a text box for entry of a destination or predefined destinations that are selectable by the rider 104. In this example, the user interface 128 may identify one or more persons who may be destinations for transportation of the rider 104. Example persons who may be a destination include, but are not limited to, a parent of the rider, another family member of the rider, or a friend of the rider.

The method of FIG. 4 includes receiving 402 identification of a person as a destination for a ride for a rider. Continuing the aforementioned example, the rider 104 may interact with the user interface 128 to select one of the identified persons. In response to the selection, the rider sharing application 108 may control the I/O module 134 to communicate an identifier of the selected person to the server 110. The rider sharing manager 112 of the server 110 may receive the identifier of the selected person.

The method of FIG. 4 includes receiving 404 a request for transportation to a destination proximate the identified person. Continuing the aforementioned example, the ride sharing application 108 may generate a request including identification of the person as the destination. For example, in response to the selection, the ride sharing application 108 may control the I/O module 134 to communicate a request including the identifier of the selected person to the server 110. The rider sharing manager 112 of the server 110 may receive the identifier of the selected person. The ride sharing manager 112 may determine current position coordinates of the identified person based on a calendar entry, a location history, or the like of the identified person. For example, the ride sharing manager 112 may access a calendar of the identified person in its memory 116 or a computing device associated with the identified person to determine the location of the identified person at a time of the same day of the week and/or the same time as an expected arrival time at the destination. The calendar entry may indicate the location (e.g., the position coordinates) of the identified person such that directions to the location may be determined.

The method of FIG. 4 includes communicating 406, to a computing device of a driver, a request to provide transportation to the rider based on the determined position coordinates of the identified person. Continuing the aforementioned example, the rider sharing manager 112 of the server 110 can send a request to the driver's computing device 118 for transporting the rider 104 to the person 132. The request can include the position coordinates of the person 132 that were based on that person's calendar entry or location history as described in the example of step 404.

The method of FIG. 4 includes managing 408 transportation of the rider to the destination by the driver. Continuing the aforementioned example, the driver 120 can accept the request to driver the rider 104 to the destination. Particularly, the ride sharing application 124 of the driver's computing device 118 can control the user interface 126 to present information of the request. The driver 120 may accept the ride request for the rider 104 and use the user interface 126 to input whether the ride request is accepted. The ride sharing application 124 may receive the input indicating acceptance of the ride request. In response to receipt of the input, the ride sharing application 124 may communicate a message to the server 110 to indicate that the ride request is accepted. If the ride request is accepted, the ride sharing manager 112 may communicate the acceptance to the rider's computing device 102 along with information about the driver 120, such as a description of the driver's automobile, estimated time of arrival for pickup, and the like. Subsequently, the rider 104 may await pickup by the driver 120 for transport to the location of the person 132.

The present subject matter may be a system, a method, and/or a computer program product. The computer program product may include a computer readable storage medium (or media) having computer readable program instructions thereon for causing a processor to carry out aspects of the present subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a RAM, a ROM, an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network, or Near Field Communication. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++, Javascript or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present subject matter.

Aspects of the present subject matter are described herein with reference to flowchart illustrations and/or block diagrams of methods, apparatus (systems), and computer program products according to embodiments of the subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A method comprising:
receiving a request for transportation to a destination proximate a mobile computing device;
determining position coordinates of the mobile computing device;
communicating, to a computing device of a driver associated with the request, the position coordinates of the mobile computing device for indicating the position coordinates as the destination for the request;
determining updated positioned coordinates of the mobile computing device; and
communicating, to the computing device of the driver associated with the request, the updated position coordinates of the mobile computing device.

2. The method of claim 1, wherein receiving a request for transportation comprises receiving the request from a computing device of a rider designated to receive the transportation, or a computing device of an agent of the rider designated to receive the transportation.

3. The method of claim 1, wherein receiving a request for transportation comprises receiving an indication that the destination is a location proximate a person associated with the mobile computing device.

4. The method of claim 1, wherein determining position coordinates comprises receiving current position coordinates from the mobile computing device, or another computing device associated with the mobile computing device.

5. The method of claim 1, wherein the position coordinates comprise global positioning system (GPS) coordinates of the mobile computing device.

6. The method of claim 1, further comprising communicating, to the computing device of the driver associated with the request, continuously and automatically updated positioned coordinates to the mobile computing device.

7. The method of claim 1, further comprising presenting, at the computing device of the driver, an indication of the destination based on the position coordinates.

8. The method of claim 7, further comprising presenting, at the computing device of the driver, directions for traveling to the destination based on the position coordinates.

9. The method of claim 1, further comprising:
presenting, at a computing device of a rider or an agent of the rider designated to receive the transportation, a user interface for receiving identification of the mobile computing device, and
wherein determining position coordinates comprises determining the position coordinates based on the identification of the mobile computing device.

10. The method of claim 1, wherein determining position coordinates comprises determining the position coordinates based on a calendar entry indicating a location of a user of the mobile computing device, or based on a location history of the user of the mobile computing device at a time of the same day of the week and/or the same time as an expected arrival time at the destination.

11. A computing device comprising:
a ride sharing manager configured to:
receive a request for transportation to a destination proximate a mobile computing device;
determine position coordinates of the mobile computing device;
communicate, to another computing device of a driver associated with the request, the position coordinates of the mobile computing device for indicating the position coordinates as the destination for the request;
determine updated positioned coordinates of the mobile computing device; and
communicate, to the computing device of the driver associated with the request, the updated position coordinates of the mobile computing device.

12. The computing device of claim 11, wherein the ride sharing manager is configured to receive the request from a computing device of a rider designated to receive the transportation, or a computing device of an agent of the rider designated to receive the transportation.

13. The computing device of claim 11, wherein the ride sharing manager is configured to receive an indication that the destination is a location proximate a person associated with the mobile computing device.

14. The computing device of claim 11, wherein the ride sharing manager is configured to determine position coordinates comprises receiving current position coordinates from the mobile computing device, or another computing device associated with the mobile computing device.

15. The computing device of claim 11, wherein the ride sharing manager is configured to communicate, to the computing device of the driver associated with the request, continuously and automatically updated positioned coordinates to the mobile computing device.

16. The method of claim 11, wherein the ride sharing manager is configured to present, at the computing device of the driver, an indication of the destination based on the position coordinates.

17. A method comprising:
at a computing device:
receiving a request for transportation to a destination proximate a mobile computing device;
determining first position coordinates of the mobile computing device at a first time;
presenting directions for driving to the determined first position coordinates;
determining second position coordinates of the mobile computing device at a second time different than the first time; and
presenting directions for driving to the determined second position coordinates.

18. The method of claim 17, wherein the first and second position coordinates comprise global positioning system (GPS) coordinates.

19. The method of claim 17, further comprising receiving, at the computing device, input via a user interface for accepting the request.

20. The method of claim 19, further comprising determining, at the computing device, directions for driving to the second position coordinates.
